(19) United States
(12) Patent Application Publication
(10) Pub. No.: US 2005/0223883 A1
(43) Pub. Date: Oct. 13, 2005

(54) Standoff land attack-expanded response device computer

(76) Inventors: Aaron L. Eggemeyer, Chester, IL (US); James V. Leonard, St. Charles, MO (US); Robert K. Menzel, Lake Saint Louis, MO (US); Richard E. Meyer, Florissant, MO (US)

Correspondence Address: THOMPSON COBURN, LLP, ONE US BANK PLAZA, SUITE 3500, ST LOUIS, MO, 63101, US

(21) Appl. No.: 10/796,218

(22) Filed: Mar. 9, 2004

(51) Int. Cl. B64D 1/04

(52) U.S. Cl. 89/1.11

(57) ABSTRACT

A system for an aircraft that includes an attachment point for a store and a data management system that communicates data amongst a plurality of mobile platform systems and an operator. The data management system includes a docking station and a data link operatively associated with the attachment point thereby allowing the store and at least one of the mobile platform systems to communicate. The system includes a circuit that docks to the docking station and includes an input, a first data port, and a second data port. The circuit accepts operator commands via the input and sends commands to the data link, and to the store, based on the inputs via the second data port. Additionally, the circuit accepts imaging from the store via the second data port.

### FIELD OF THE INVENTION

This invention relates generally to an operator interface for a mobile platform and, more particularly, to a circuit and method for increasing the types of stores an aircraft may control without modifying the data management system of the aircraft.

### BACKGROUND OF THE INVENTION

Modern combat aircraft rely on their onboard data management system to communicate with, and control, smart weapons stored on attachment points of the aircraft. While a weapon is stored on the attachment point, a MIL-STD-1553 data bus typically provides connectivity between the weapon and the data management system. Once the weapon has been launched, a data link pod on the aircraft store pylon typically provides an RF link between the data management system and the airborne weapon. One such data link pod is the AN/AWW-13 pod developed by the Naval Avionics Center and described in publication number 1342AS114 dated Nov. 15, 1988.

Additionally, modern weapons such as the exemplary SLAM-ER (Standoff Land Attack Missile-Expanded Response) missile, available from the Boeing Co. of Chicago, Ill., provide a channel of video imaging from a seeker located on the weapon. The imaging allows an aircrew member onboard the aircraft to see where the missile is headed. By issuing commands via the RF link, the aircrew member may then adjust the weapon's trajectory accordingly. Moreover, with the current state of world affairs, the imaging allows the aircrew member to identify high value targets that suddenly appear and then to re-task the weapon accordingly. Clearly, such man-in-the-loop (MITL) capabilities provide a degree of flexibility that is highly sought after. The dual role F/A-18, also available from the Boeing Co. of Chicago, Ill. represents one exemplary platform that may be fully equipped to carry MITL weapons such as the SLAM-ER

Unfortunately, despite the capability of the data link incorporated in the AN/AWW-13 pod, many platforms would require extensive modification to incorporate MITL capabilities. For instance, not all P-3 maritime patrol aircraft, available from the Lockheed Martin Corporation of Bethesda, Md., are configured for MITL weapons. Instead, these P-3s typically use the AN/AWG-19 HACLCS to launch non-MITL weapons such as the Harpoon cruise missile (also available from the Boeing Company of Chicago, Ill.).

To upgrade such platforms to include MITL capability would require expensive, time-consuming modifications that would take the platform out of service during the modification. In addition, those skilled in the art will recognize that the modified platform will have to be recertified, thereby aggravating the cost and delay associated with the upgrade.

Moreover, many modern weapons (the SLAM-ER for example) allow new mission plans to be downloaded into them during flight, but before launch from the platform. Typically, the new missions are programmed into an electronic file using mission planning software. The resulting mission file is downloaded into the weapon prior to launch. An exemplary mission planning application is the Joint Mission Planning System (JMPS) developed by the China Lake Naval Weapons Station of China Lake, Calif. As with MITL capability, the platform must be equipped to accommodate the JMPS system. Otherwise, adding planning capability to the platform requires another expensive and time-consuming platform modification.

### SUMMARY OF THE INVENTION

It is in view of the above problems that the present invention was developed. The present invention includes apparatus and methods for extending the capabilities of mobile platforms, heretofore incapable of MITL weapons control, to provide MITL capability without requiring platform modification and its attendant disadvantages.

In particular, the present invention includes apparatus to operate a MITL capable weapon from a pre-existing aircraft not otherwise capable of controlling the missile. The apparatus may be a personal computer (e.g. a ruggedized lap-top computer) that accepts data and sends commands from several interfaces. First, the laptop accepts operator inputs entered via a joystick, via an external data entry panel, or via its keyboard and a graphical user interface. Subsequently, the PC transforms the inputs into commands for the attachment point subsystem, the data link pod, and the weapon.

The commands are then sent to the appropriate destinations over, for example, one or more MIL-S-1553 buses. In turn, the laptop accepts feedback from the attachment point subsystem, the data link pod, and the weapon over these 1553 bus(es). Additional communications between the laptop and the weapon may occur over discrete input and output channels. The laptop also accepts imaging data from the weapon via the data link pod despite the lack of proper aircraft outfitting for such capability. The imaging may then be displayed, recorded, and played back on the laptop. In addition, the imaging may be uploaded to the aircraft data management system via an aircraft docking station to which the laptop is docked.

Additionally, the apparatus may be configured to execute mission-planning software such as the JMPS (Joint Mission Planning System) application. Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a perspective view of an aircraft in accordance with a preferred embodiment of the present invention.

FIG. 2 is a block view of a system in accordance with a preferred embodiment of the present invention;

FIG. 3 is a flowchart of a method in accordance with another preferred embodiment of the present invention; and

FIG. 4 is a flowchart of another method in accordance with a further preferred embodiment of the present invention.

### DETAILED DESCRIPTION OF THE PREFERRED EMBODIMENTS

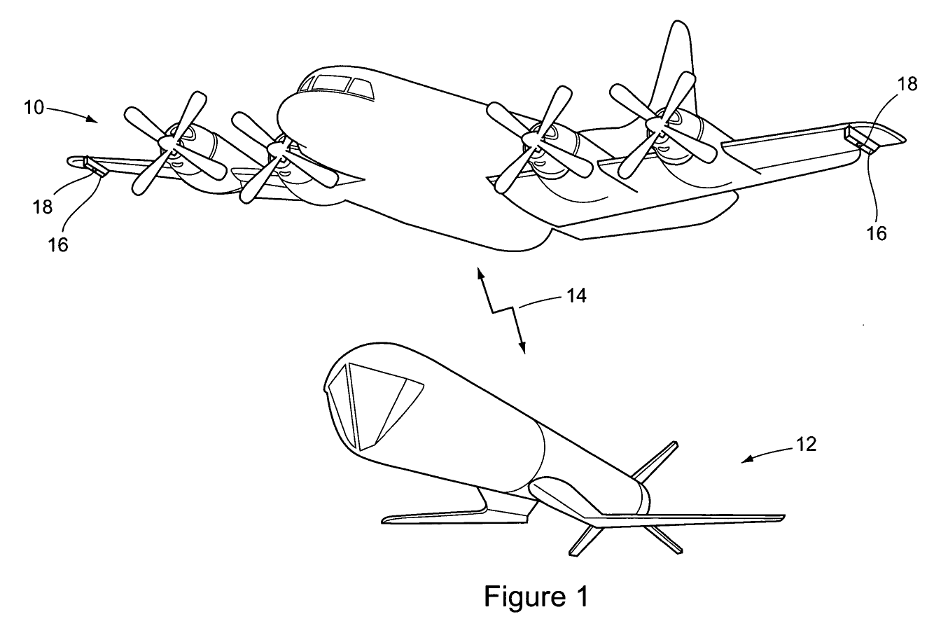

Referring to the accompanying drawings in which like reference numbers indicate like elements, FIG. 1 illustrates an aircraft 10 having launched a MITL weapon 12, and a bi-directional electromagnetic (e.g. RF) link 14 allowing communication between the two vehicles. In particular, the figure illustrates a store pylon 16 on the aircraft 10 for attaching the weapon 12 under a wing (or fuselage) of the aircraft. Also shown schematically is the data link pod 18 through which the aircraft 10 communicates with the weapon 12 after launch.

An exemplary combination of data link pod 18 and weapon is the AN/AWW-13 pod and the SLAM-ER missile. Note should be made that the data link pod 18 is compliant with MIL-STD-1760. Exemplary data links 18 for use in cooperation with the present invention are described more fully by the co-owned, co-pending U.S. patent application Ser. No. 10/424,948, entitled Test Adapter For A Weapon Store Test Set and filed on Apr. 28, 2003, which is incorporated by referenced herein as if set forth in its entirety. Moreover, wheras a weapon 12 is described herein, the present invention is not so limited. For instance, a MIL-S-1760 compatable store may be employed without deviating from the spirit or scope of the present invention. Similarly, any combination of mobile platform and store may be employed (e.g. a ship or submarine and a submersible vehicle or torpedo) may be retrofitted according to the principles of the present invention without deviating from the invention's spirit or scope.

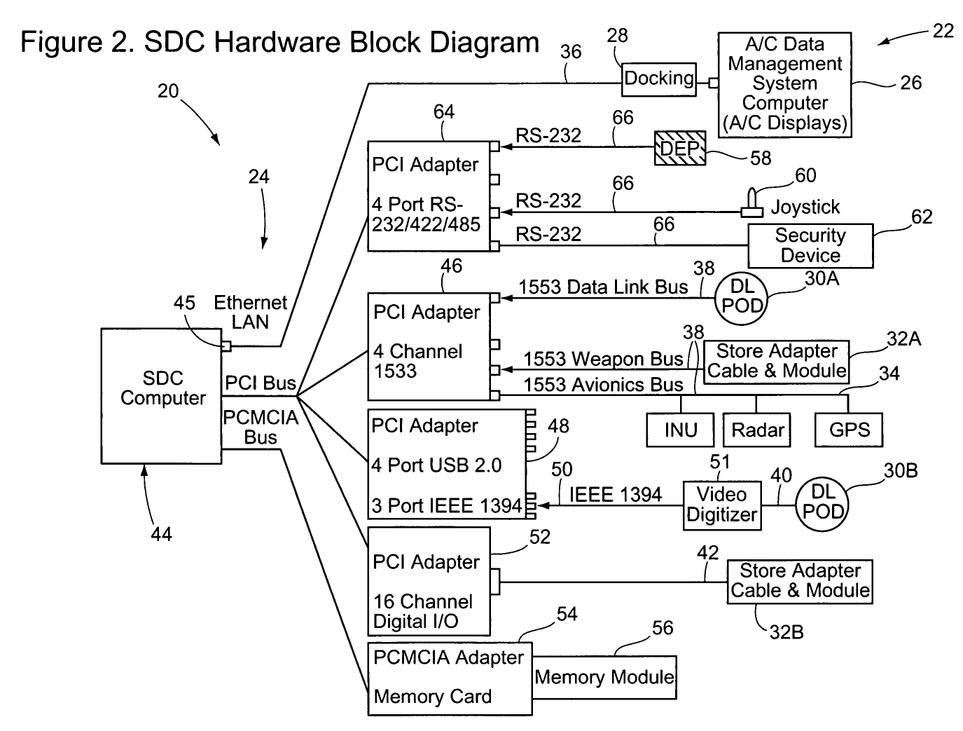

With reference now to FIG. 2, an integrated system 20, in accordance with the principles of another preferred embodiment of the present invention, is shown. Generally, the system 20 includes selected components from pre-existing aircraft systems 22 and additional components 24 that supply further capability to the aircraft 10. The various individual components of the system 20 will be briefly discussed first, herein, before turning to a discussion of the integrated operation of the system 20.

The pre-existing components 22 include the following: the aircraft data management system 26 including a docking port 28, the data link pod 30, the store adaptor subassembly 32, and other aircraft weapons related systems 34 (e.g. INU—Inertial Navigation Unit, RADAR, and GPS systems). These pre-existing components 22 communicate with one another via various interconnect technologies. For instance, the docking station provides Ethernet connectivity 36. Several MIL-S-1553 buses 38 link portions 30A of the data link pod 30, portions 32A of the store adaptor, and the other systems 34. Another portion 32B of the store adaptor 32 communicates via hardwired links 42.

With continuing reference to FIG. 2, the additional components 24 includes a circuit 44 that may be, or include, a ruggedized personal computer (PC) or firmware. In a prefered embodiment the circuit 44 is an industrial laptop computer, Model Number FXPAC6 P42G, available from Dolch Computer Systems of Fremont, Calif. and may be docked at the docking station 28 via an Ethernet port 45. Additionally, the computer 44 may include several PCI adaptors as follows. A first PCI adaptor 46 may be included for translating the bidirectional communications betweeen the computer 44 and the various MIL-S-1553 buses 38. Portion 30B of the data link 30 accepts imaging data from the weapon 12. The data link 30B also communicates this imaging over a hardwired cable 40 to a video digitizer 51. In turn, the digitizer 51 digitizes the imaging and transmits it to a PCI adaptor 48, preferentially in an IEEE-1394 compliant format.

A third PCI adaptor 52, enables the computer 44 to read and generate the discrete signals carried by the wires 42. Finally, a PMCIA adaptor card 54 may allow the addition of a memory 56, to be addressed later herein, to the computer 44.

Another PCI adaptor 64 may provide RS-232 connectivity 66 to an external data entry panel 58, a joystick 60, and a security device 62. The data entry panel 58 and joystick 60 allow the aircrew member to enter commands for the weapon 12 to the computer 44. In parallel the security device 62 prevents unauthorized personnel from accessing the system 20 in a manner well known in the art. While the devices 58 to 62 have been described as being peripheral components, the computer may include these components via internal hardware, software, or graphical user interfaces. Thus, the various pre-exisitng components 22 of the aircraft 10 and the additional components 24 have been briefly described.

Still referring to FIG. 2, the integrated system 20 operates as follows. Aircrew members onboard the aircraft 10 enter commands and other inputs associated with the store 12 (see FIG. 1) by way of the data entry panel 58 and joystick 60 (e.g. guiding the weapon with the joystick). In turn, the computer 44 receives the inputs via the PCI adaptor 64. Subsequently, the computer 44 translates the inputs to appropriate MIL-S-1553 messages and discretes and transmits the resulting outputs via the appropriate PCI card (either 46 or 52). In this manner, the operator may command the data link pod 30, the store adaptor, and the other systems 34 independently of the data management system 26 of the aircraft 10. In similar manner, the operator may view status information returned from these subsystems 30 to 34 via the MIL-S-1553 buses 38 and the discrete inputs 42 independently of the aircraft 10. Of course, the MITL capable weapon 12 communicates over the weapon's MIL-S-1553 data bus via the store adaptor 32A before launch.

Notably, the data link pod 30B may be receiving imaging from the weapon 12 after launch. Those skilled in the art will understand that the imaging is typically of the infrared or visible portion of the electro magnetic spectrum, though the current invention is not so limited. If imaging is being received, the video digitizer 51 reformats the imaging to an IEEE-1394 format and transmits the reformated imaging to the PCI adaptor 48 via the cable 50. The computer 44 then displays the imaging on either an internal display (e.g. the computer's monitor) or a monitor associated with the data entry panel 58. In addition, the computer 44 may store the imaging internally or forward it to the data management system 26 via the docking station 28.

Accordingly, the aircrew member has the information and controls available at the computer 44 to operate the weapon and associated aircraft systems independently of the aircraft data management system 26. In particular, during the terminal phase of the weapon's flight the aircrew member may re-task the weapon to a secondary target visible in the imaging if the primary target has dissappeared or been destroyed. Moreover, considering the fluid nature of modern combat, wherein targets appear and dissapear quickly, the weapon may be re-tasked upon the sudden observance of a high value target in the imaging.

As those skilled in the art will recognize, a program or software application resides within the computer 44 to receive the crewmember commands, translate them into suitable outbound commands for the data link 30, store adaptor 32, and the other systems 34. The software also includes the capability to translate incoming data from the data link 30, store adaptor 32, the other systems 34, and in particular the video digitizer 51 into a format suitable for display on the data entry panel 58.

Those skilled in the art will recognize that the computer 44, of the present embodiment, resides in parallel with the pre-existng weapons systems. Thus, the aircraft 10 may operate non MITL weapons on the data link pod 30 when the computer 44 is idle or absent. Moreover, the aircraft 10 may be configured with multiple stores adaptors 16 each individually tailored to operate either MITL capable weapons 12, or not, as desired by the aircraft owner. Likewise, the computer 44 may be used to operate non-MITL weapons.

In yet another embodiment, the present invention also provides the capability to allow mission planning onboard the aircraft 10 whether the aircraft is configured to allow the planning capability or not. By storing a mission planning program, or application such as JMPS, in the computer 44, the operator may plan a mission for the weapon 12 on the computer 44. In particular, the operator may run the mission planning software, accessing relevant data from the various onboard systems (e.g. the INU, RADAR, and GPS) as necessary to create and download a program into the weapon 12 via the weapons data bus 38 and the store adaptor 32A. Thus, the present invention also provides the benefit of mission planning for weapons even if the aircraft is not so equipped.

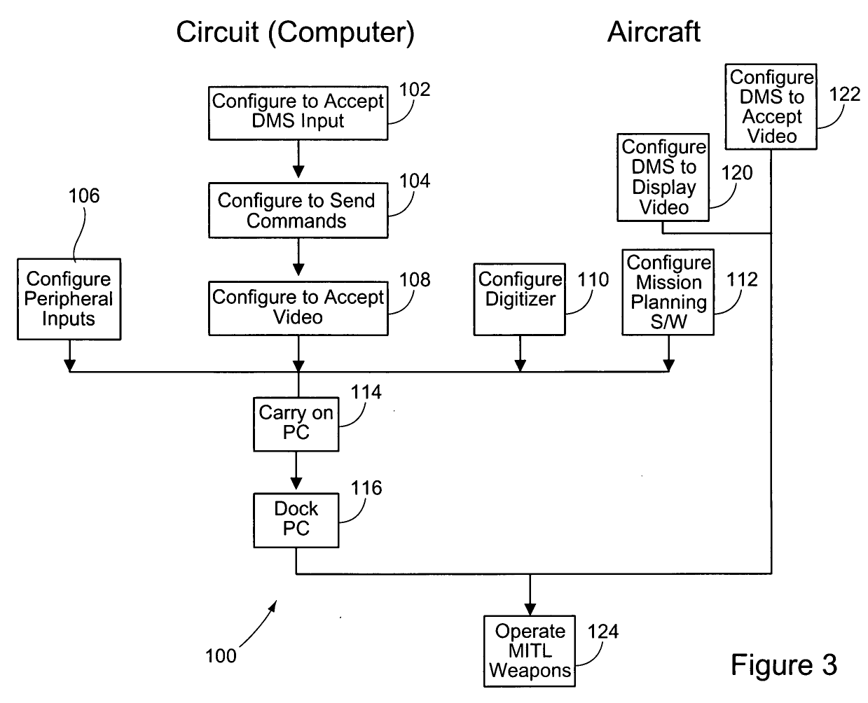

In another preferred embodiment of the present invention, a method of adding MITL capability to non MITL capable platforms is also provided. In general, the exemplary method 100 illustrated in FIG. 3 includes configuring the computer 44 and, if desired, configuring the aircraft 10. It will be understood hereing that the term “configure” includes connecting cabling and other hardware. Moreover, for embodiments including firmware and other custom circuits in lieu of the computer 44, “configure” will be construed to mean programming logic devies (e.g. EEPROM) and otherwise physically configuring the circuit (e.g. adjusting gains or filter settings). Additionally, it will be further understood that the exact ordering of the steps shown need not be followed to adhere to the spirit and scope of the present invention.

With reference now to operation 102 of FIG. 3, configuring the computer includes installing software to allow the computer to accept and translate weapon control inputs from the data entry panel. Configuring the computer also includes installing software to send the commands to the data link, store adaptor, and other aircraft systems (see operation 104). If peripheral devices (e.g. a data entry panel or joystick) are to be used in lieu of internal devices, then software may also be required to control these external components. See step 106. Of course, all of the software entities may be included in one integrated application.

Additionally, configuring the computer may include installing software to accept the video imaging (and if necessary digitize it). See step 108. The video functions may also be included in the single, integrated application program. Depending on the digitizer chosen, it too may require configuration, particularly in terms of initializing software or the addition of video capture cards. In the alternative, if the computer is to include an internal digitizer, than additional computer configuration may be required as in step 110. Additionally, if mission planning capability is desired, the mission planning software should be installed as in operation 112. Preferentially, the computer is configured prior to carrying it onboard the aircraft in opertion 114. Likewise, the computer may be docked to the work station, in operation 116, at any time.

In the meantime, some minimal configuration of the aircraft may be desirable. If it is desired for the data management system to either accept, store, or display, the video imaging from the computer 44 (see FIG. 2) then accomodations (e.g. allocation of memory or selection of a display) may be made. See steps 120 and 122. Though, because the present invention provides all of these capabilities within the computer 44, such aircraft configurations are not necessary for practicing the present embodiment of the invention. Once the configuration of the computer and aircraft (if necessary) are complete, and the computer is docked to the work station, MITL weapons may be operated from the aircraft, as in step 124.

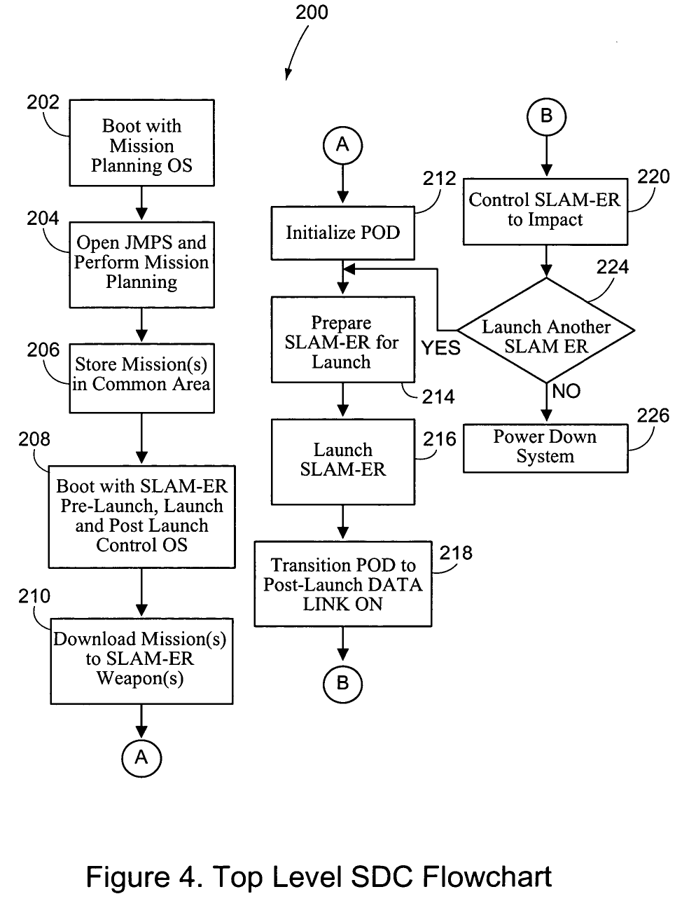

Thus, as further illustrated by FIG. 4, the aircrew member may operate a MITL weapon 12 with the computer 44 as follows. First, the aircrew member docks the computer to the aircraft docking station and boots the machine as in operation 202. The crewmember may then open the mission planning software and plan a mission. See operation 204.

In parallel, the operator may have opened the software containing the weapon pre-launch, launch, and post launch routines as shown at operation 208. Once the misssion (or revised mission is ready), the crewmember then downloads the mission to the memory onboard the weapon via a MIL-S-1553 bus that communicates with the weapon in operation 210. As the time for launching the weapon approaches, the aircrew member initializes the data link pod as in operation 212. In operation 214, at a time desirable from a mission execution perspective, the crewmember prepares the weapon for flight by initializing it with the aircraft's current attitude and GPS coordinates (as acquired from the systems onboard the aircraft or elsewhere). Then, at the planned time, the crewmember performs operation 216 to launch the weapon. The crewmember then commands the data link pod to “Post Launch” mode to turn the data link on. See step 218.

With the weapon away, the aircrew member controls the flight of the weapon as desired according to the data and imaging received from the weapon. In particular, because the present invention provides the crewmember real time video feedback from the weapon, the operator may accurately control the weapon through the terminal phase of the mission. See operation 220.

With continuing reference to FIG. 4, the crewmember may then decide whether to launch another weapon. If so, the crewmember returns from operation 224 to operation 214. Of course, the crewmember may also plan a mission for the next weapon before launching it. If no other weapon launches are desired, operation 226 shows the system (i.e. the computer and data link) being deactivated.

In view of the foregoing, it will be seen that the several advantages of the invention are achieved and attained. In particular, a mobile platform (that heretofore did not possess MITL capability) has been enhanced with MITL capability. Notably, the embodiments described herein, provided the enhancement without requiring extensive modification and recertication of the platform. Accordingly, the present invention provides a less expensive and quicker system and method to upgrade the capabilities of non-MITL weapons platforms.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A system for a mobile platform including an attachment point for a store, a data management system for communicating data amongst a plurality of other mobile platform systems and an operator and including a docking station, the platform including a data link operatively associated with the attachment point to allow the store and at least one of the platform systems to communicate, the system comprising:
a circuit adapted to dock to the docking station and including:
an input for accepting commands from the operator,
a first data port for sending commands to at least one of the data link and the store based on the commands; and
a second data port for accepting imaging from the store.

2. The system according to claim 1, further comprising a video digitizer associated with the circuit to communicate with the second data port and to digitize the imaging.

3. The system according to claim 1, further comprising a video digitizer adapted to be interposed between the data link and the second data port to digitize the imaging from the store and to forward the digitized imaging to the second data port.

4. The system according to claim 3, further comprising an IEEE-1394 compatible cable adapted to connect the digitizer and the second data port.

5. The system according to claim 1, further comprising a memory for storing a mission-planning program to be executed by the circuit.

6. The system according to claim 1, further comprising a data entry device adapted to communicate with the circuit via the input.

7. The system according to claim 6, further comprising an RS-232 compatible cable adapted to connect the date entry device and the input.

8. The system according to claim 6, further comprising a joystick associated with the device.

9. The system according to claim 1, wherein the circuit is adapted to forward the imaging to the data management system display.

10. The system according to claim 1, wherein the circuit is adapted to be carried onboard the mobile platform.

11. The system according to claim 1, further comprising at least one of a firmware containing the circuit and a personal computer containing the circuit.

12. The system according to claim 1, wherein the imaging is one of at least infrared and visible electromagnetic radiation.

13. A computer for use on a mobile platform including an attachment point for a store, a data management system for communicating data amongst a plurality of mobile platform systems and an operator and including a docking station, the mobile platform including a data link operatively associated with the attachment point to allow the store and at least one of the mobile platform systems to communicate, the computer comprising:
a docking port to dock to the docking station;
an input for accepting commands from the operator;
a data port for sending commands to at least one of the data link and the store based on the inputs; and
an image port for accepting imaging from the store.

14. The computer according to claim 13, further comprising a video digitizer to communicate with the image port and to digitize the imaging.

15. The computer according to claim 13, further comprising an external video digitizer adapted to be interposed between the data link and the image port to digitize the imaging from the store and to forward the digitized imaging to the image port.

16. The computer according to claim 15, wherein the image port is IEEE-1394 compliant.

17. The computer according to claim 13, further comprising a memory for storing a mission-planning program to be executed by the computer.

18. The computer according to claim 13, further comprising an external data entry device adapted to communicate with the input.

19. The computer according to claim 18, wherein the input is an RS-232 port adapted to communicate with the date entry device.

20. The computer according to claim 18, further comprising a joystick associated with the device.

21. The computer according to claim 13, wherein the computer is adapted to forward the imaging to the data management system.

22. The computer according to claim 13, wherein the computer is adapted to be carried onboard the mobile platform.

23. The computer according to claim 13, wherein the computer is a laptop computer.

24. The computer according to claim 13, wherein the imaging is one of at least infrared and visible electromagnetic radiation.

25. A mobile platform comprising:
an attachment point for a store;
a data management system for communicating data between a plurality of mobile platform systems and an operator, the data management system including a docking station;
a data link operatively associated with the attachment point to allow the store and at least one of the mobile platform systems to communicate, and
a circuit adapted to dock to the docking station and including:
an input for accepting commands from the,
a first data port for sending commands to at least one of the data link and the store based on the inputs; and
a second data port for accepting imaging from the store.

26. The mobile platform according to claim 25 wherein the mobile platform is an aircraft.

27. The mobile platform according to claim 26, wherein the aircraft is a P-3.

28. The mobile platform according to claim 25, further comprising an AN/AWW-13 pod including the data link.

29. The mobile platform according to claim 22, wherein the store is a SLAM-ER weapon.

30. A method of preparing a mobile platform to accept a store, the mobile platform including an attachment point for a store, a data management system for communicating data amongst a plurality of mobile platform systems and an operator, the data management system including a docking station, and a data link operatively associated with the attachment point to allow the store and at least one of the mobile platform systems to communicate, the method comprising:
configuring a circuit to accept operator inputs, the circuit adapted to dock to the docking station;
configuring the circuit to send commands to at least one of the data link and the store based on the inputs; and
configuring the circuit to accept imaging from the store.

31. The method according to claim 30, further comprising configuring the data management system to accept the imaging from the circuit.

32. The method according to claim 31, further comprising configuring the data management system to display the imaging.

33. The method according to claim 30, further comprising docking the circuit to the docking station.

34. The method according to claim 30, further comprising configuring a video digitizer to digitize the imaging.

35. The method according to claim 30, further comprising configuring the circuit to execute mission-planning program.

36. The method according to claim 30, further comprising configuring the circuit to communicate with an external data entry device.

37. The method according to claim 30, further comprising carrying the circuit onboard the mobile platform.
